(19) United States
(12) Patent Application Publication
(10) Pub. No.: US 2019/0171535 A1
(43) Pub. Date: Jun. 6, 2019

(54) Data Transmission Between Computation Units Having Safe Signaling Technology

(71) Applicant: SIEMENS MOBILITY GMBH, Muenchen (DE)

(72) Inventor: HANS-HELMUT SCHWEISSTHAL, WOLFENBUETTEL (DE)

(21) Appl. No.: 16/320,618

(22) PCT Filed: Jun. 26, 2017
(86) PCT No.: PCT/EP2017/065637

§ 371 Date: Jan. 25, 2019

(30) Foreign Application Priority Data
Jul. 25, 2016 (DE) 10 2016 213 554.6

(51) Int. Cl. G06F 11/16; G06F 11/30; G06F 11/07

(52) U.S. Cl. CPC G06F 11/1625; G06F 11/1604; G06F 11/0796; G06F 11/1616; G06F 11/3041

(57) ABSTRACT

An input and output module transmits and receives data via a data line. The input and output module includes a protocol machine for a security protocol for data transfer and a clock. The protocol machine and instructions for clock processing are stored as sequence control in a read-only memory of the input and output module.

The invention relates to a system and a method for transmitting data between computation units having safe signaling technology.

The term “having safe signaling technology” is intended to be understood within the context of the present invention to be concordant with the corresponding term in railway technology. The reference used can be the EN 50129 standard, for example. “Having safe signaling technology” fundamentally means that the probability of defined risk occurring is below a prescribed threshold value. Safe signaling technology is normally produced by virtue of calculations being performed redundantly. Preferably, the calculations are performed in diversely redundant fashion. The terms “redundant” and “multichannel” are used synonymously below. In this regard, a computation unit can contain a first piece of hardware and a different, i.e. diverse, second piece of hardware, for example. A calculation is then performed on the first hardware and on the second hardware each time and the respective results are compared. Only if the results are in accord is the calculation deemed correct and is further processing performed. Alternatively, the first and second hardware may also be in identical form. Diversity is then introduced at the level of the software, for example by virtue of a calculation being performed redundantly on the basis of different programs, which are in different programming languages, for example, on the first and the second hardware. Diversity can also be implemented at the level of the hardware and at the level of the software. Redundancy is not restricted to the use of just two channels in this case.

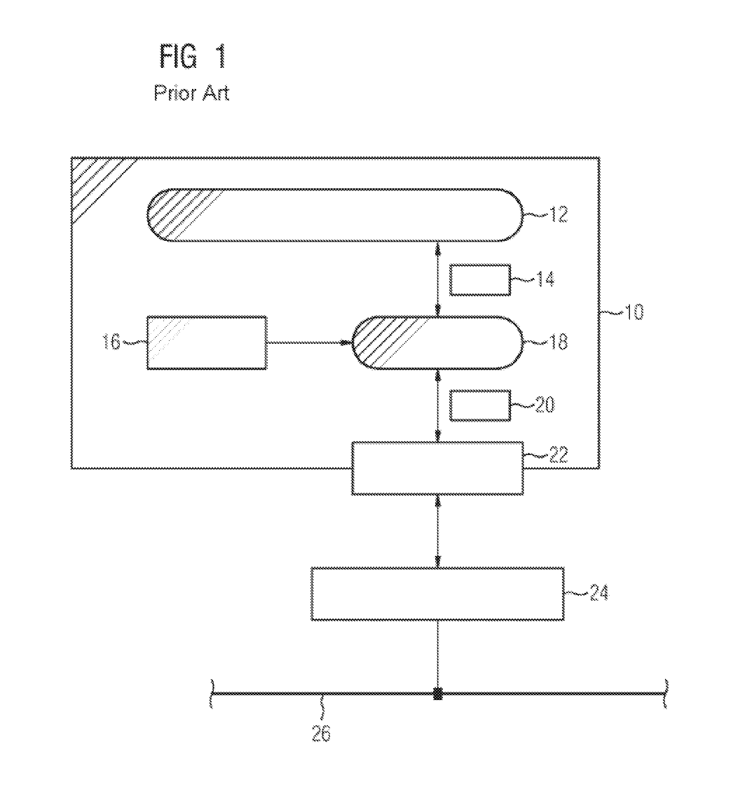

The prior art is illustrated schematically in FIG. 1.

A computation unit 10, which has safe signaling technology as set out above, e.g. a main computer 10 having safe signaling technology, in this case comprises a clock 16 having safe signaling technology and is configured to execute a data link protocol 18 for data transmission on the basis of safe signaling technology, just like any application 12. A clock having safe signaling technology is moreover designed such that this clock operates strictly monotonously, i.e. does not stop and always runs only in one direction. Data 14 produced by the application 12 can then be forwarded, as data 20 protected by means of the data link protocol 18 and provided with a timestamp of the safe clock 16, via an input and output memory 22, e.g. DP-RAM or FIFO, to an input and output module 24 that does not have safe signaling technology, for the purpose of transmission via a data line 26, e.g. a bus, a LAN, etc., to an analogously configured computation unit (not depicted in FIG. 1) having safe signaling technology. Synchronization of the clocks of the signal-oriented computation units can be effected in this case by means of conventional synchronization methods, e.g. based on PTP (Precision Time Protocol) as per IEC 1588, which is available as freeware, for various operation systems.

The input and output module can in this case be provided, by way of example, as a serial UART, as an Ethernet controller or as a small computer, e.g. on a Linux basis. The input and output module normally used is conventional, mass-produced components (what are known as COTS “commercial off-the-shelf” components), which do not have safe signaling technology. The signal integrity is provided in the main computer, which has safe signaling technology.

An example of a main computer having safe signaling technology is a Simis TCC series computer from Siemens. The data link protocol used for data transmission can be the “Safe Link Layer” protocol based on UNISIG Subset 057, for example. An input and output module as described above can either be permanently connected on a board as a circuit component to a computer having safe signaling technology (such as e.g. a SIMIS FM computer from Siemens) or can be plugged in as a communication assembly in an assembly frame (such as e.g. as a PNET5 assembly within the context of the aforementioned Simis TCC).

The object of the present invention is to simplify a system for data transmission based on safe signaling technology.

According to the invention, to this end an input and output module for sending and receiving data via a data line is made available. The input and output module comprises a protocol state machine for a data link protocol for data transmission and a clock. As a result, the input and output module is configured to protect data to be transmitted by means of the data link protocol and to process received data protected by means of the data link protocol. Moreover, the input and output module is configured to provide outgoing, protected data with a timestamp, on the basis of the clock, and to compare timestamps of incoming data with the present time indicated by the clock. Instructions regarding clock processing and the protocol state machine are stored as hard sequence control in a read only memory of the input and output module in this case. An operating system therefore becomes dispensable in the input and output module.

The inventive method for transmitting data between computation units having safe signaling technology comprises the following steps: a main computer having safe signaling technology is provided. Moreover an inventive input and output module of the type described above that is couplable to the main computer is provided.

According to a first preferred embodiment, signal integrity of transmitted and received data can be ensured by virtue of the protocol state machine of the input and output module being in redundant form as a protocol state machine having safe signaling technology, and by virtue of the clock of the input and output module being in redundant form as a clock having safe signaling technology.

Preferably, the input and output module in this case is in the form of a system on chip component. Such an input and output module can then be provided in the form of a COTS component.

According to a second preferred embodiment, signal integrity of transmitted data can be ensured by virtue of an input and output assembly being provided instead of a multichannel input and output module having safe signaling technology. This input and output assembly comprises a first inventive input and output module, not necessarily having safe signaling technology, and a second inventive input and output module, not necessarily having safe signaling technology. The first input and output module is in this case in diverse form in comparison with the second input and output module. In this manner, i.e. production of diverse redundancy by combining the first and second input and output modules, it is possible for safe signaling technology to be produced.

A main computer having safe signaling technology and coupled to the input and output assembly can then additionally comprise a comparison chip configured to compare data received from the first input and output module with data received from the second input and output module.

The first and second input and output modules of the input and output assembly can also be in the form of a system on chip component and/or can be provided in the form of a COTS component.

The invention affords a series of advantages:

A main computer having safe signaling technology is relieved of load by virtue of the tasks of timestamping by means of the clock having safe signaling technology and protocol protection for outgoing data and protocol processing for incoming data being relocated to the inventive separate input and output module. This reduces project-specific integration costs for the main computer having safe signaling technology, since the data link protocol and the safe clock no longer need to be provided in the main computer. The integration costs now arise only as a one off, during the development of the inventive input and output module. For the first time, an input and output module having safe signaling technology is now available that is available as a system on chip component and comprises a protocol state machine for a data link protocol and also a clock hard-encoded in a manner based on safe signaling technology.

A further substantial advantage of the invention is that timestamping of outgoing data and checking of a timestamp of incoming data are now performed directly at hardware level in the input and output module, and not at application level in the main computer, as previously. Timestamps produced in this manner and measured propagation delays of transmitted data are much more precise than previously, since delays that previously arose as a result of propagation delays from the application level for a protocol stack to the input and output module (or vice versa) are now no longer produced. Values below one millisecond are now achievable. This is advantageous in particular in connection with realtime applications.

The relocation of the clock to the input and output module also distinctly simplifies synchronization of the clocks of the computation units involved in a data transmission. In particular, timestamps used for synchronizing the clocks are now determined by clocks having safe signaling technology.

The embodiment in which an input and output assembly having two input and output modules that do not necessarily have safe signaling technology but are diverse are used instead of a multichannel input and output module having safe signaling technology affords the advantage that what are known as “common mode” errors, e.g. in the event of power failure, can be prevented. Failure of an input and output module of the assembly can also result in a data transmission at least still being performed in a manner that is not based on safe signaling technology.

In summary, the invention can improve transmission technology for data between computation units having safe signaling technology in regard to clock calibration and loss-free data communication in real time.

According to the embodiment of the input and output module in which the protocol state machine is in redundant form as a protocol state machine having safe signaling technology and the clock is in redundant form as a clock having safe signaling technology, it is possible according to one preferred variant for the protocol state machine to be in diversely redundant form. Alternatively of additionally, the clock can be in diversely redundant form. These two measures increase the signaling safety of the input and output module each time.

In a first embodiment of a system for transmitting data between computation units having safe signaling technology, at least one computation unit having safe signaling technology comprises a main computer having safe signaling technology, i.e. a multichannel or redundant, preferably diversely redundant, main computer, and an inventive multichannel input and output module having safe signaling technology that is coupled to the main computer.

In a second embodiment of a system for transmitting data between computation units having safe signaling technology, one computation unit having safe signaling technology comprises a main computer having safe signaling technology, an input and output assembly of the type described above that is coupled to the main computer and a comparison chip configured to compare data received from the first input and output module with data received from the second input and output module.

The properties, features and advantages of this invention that are described above and the manner in which they are achieved will become clearer and more distinctly comprehensible in connection with the description of the exemplary embodiments that follows, which are explained in more detail in connection with the drawings, in which:

FIG. 1 shows a computation unit having safe signaling technology based on the prior art, which is designed for transmitting/receiving data to/from a further computation unit having safe signaling technology;

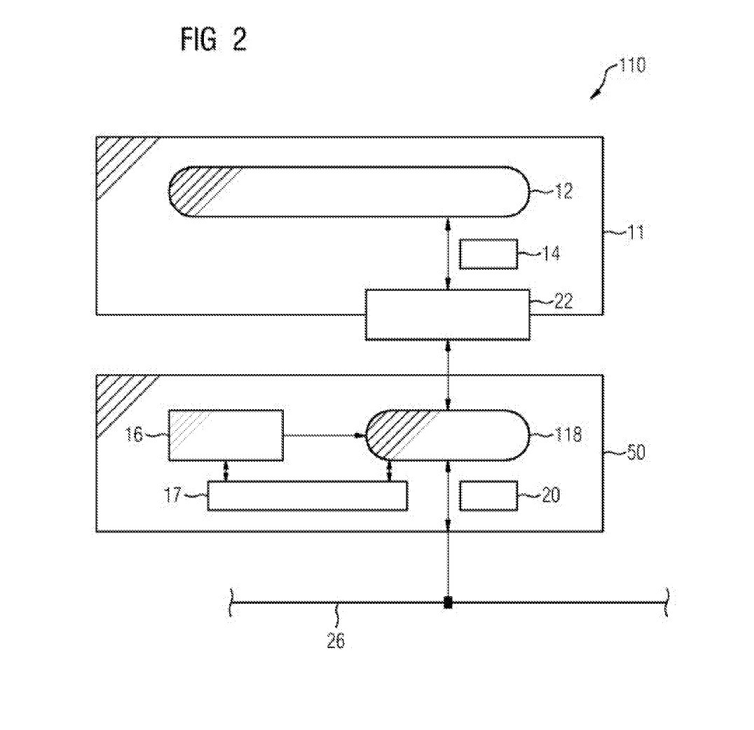

FIG. 2 shows a corresponding computation unit having safe signaling technology based on a first preferred embodiment of the invention;

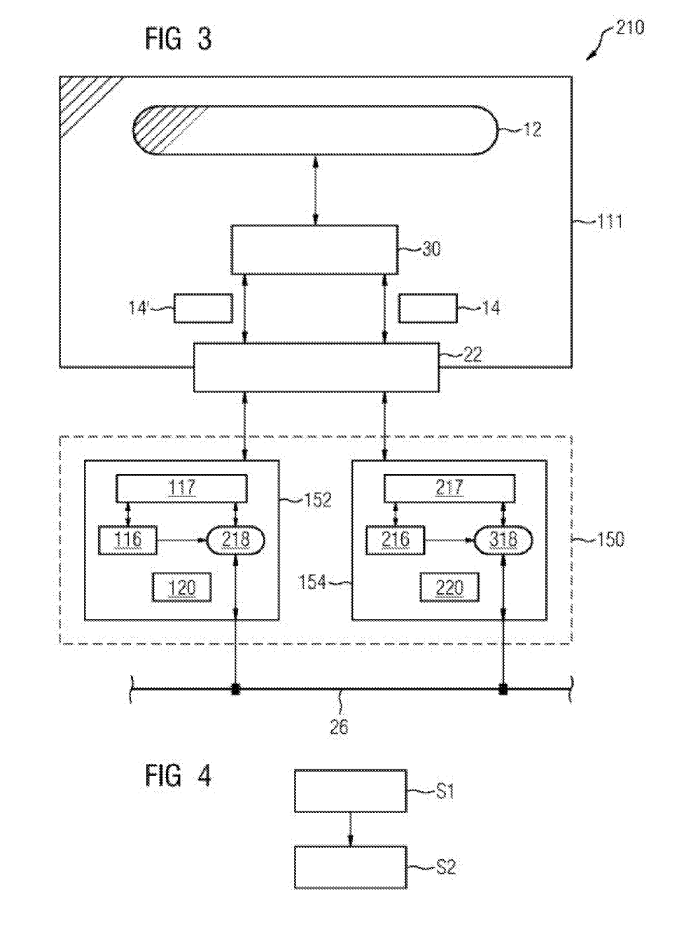

FIG. 3 shows a corresponding computation unit having safe signaling technology based on a second preferred embodiment of the invention; and

FIG. 4 schematically shows steps of a preferred embodiment of an inventive method for transmitting data between computation units having safe signaling technology.

FIG. 1 shows a computation unit 10 having safe signaling technology based on the prior art, which has already been described briefly above and is designed for transmitting/receiving data to/from a further computation unit having safe signaling technology (not shown in FIG. 1). The computation unit 10 is of multichannel design and comprises a clock 16 having multichannel protection. The computation unit 10 is configured to execute the data link protocol 18 for data transmission and an application 12 in redundant fashion. Data 14 produced by the application 12 are forwarded as data 20 protected by means of the data link protocol 18 and provided with a timestamp produced by the safe clock to an input and output memory 22 and from there are transmitted by means of a conventional input and output module, for example a serial UART or an Ethernet controller, via a data line 26, such as e.g. a bus, a LAN or the like, to a further analogously designed computation unit having safe signaling technology, which is not shown in FIG. 1.

In FIG. 1, and also FIGS. 2 and 3 that follow, hardware of multichannel design and having safe signaling technology is depicted by means of a rectangle with partial hatching in the top left-hand corners, such as e.g. the computation unit 10 or the safe clock 16 in FIG. 1. Software embodied on the basis of safe signaling technology is accordingly depicted by means of an oval with partial hatching on the left, such as the application 12 or the data link protocol 18 in FIG. 1. Corresponding counterparts not having safe signaling technology (cf. FIG. 3) exhibit no hatching each time.

FIG. 2 schematically depicts a computation unit 110 having safe signaling technology that is likewise designed for transmitting/receiving data to/from a further computation unit having safe signaling technology (not shown in FIG. 2), based on a first embodiment of the invention.

Said computation unit having safe signaling technology comprises a main computer 11 having safe signaling technology. Said main computer is configured to execute the application 12 on the basis of safe signaling technology and to forward data 14 produced by the application 12 to an input and output memory 22. In contrast to FIG. 1, the functionalities of protocol protection and timestamping are no longer resident in the main computer 11, but rather have been relocated to a separate input and output module 50 coupled to the main computer 11. The input and output module 50 is in the form of a system on chip component and comprises a clock 16 having multichannel protection and safe signaling technology and a protocol state machine 118 having safe signaling technology for executing a data link protocol 18 for data transmission. Data 14 taken from the input and output memory 22 can be protected by means of the data link protocol 18 and provided with a timestamp on the basis of the clock 16. The resultant protected and timestamped data 20 can then be transmitted to the further computation unit via the data line 26.

Since the input and output module 50 has only a known and dedicated scope of functions, the instructions for clock processing and the protocol state machine 118 can be available in a read only memory 17 of the input and output module 50 in hard-encoded fashion. Various programming languages can be used for programming, such as e.g. C, assembler, or—in the case of FPGAs without a CPU core—e.g. VHDL.

The input and output module 50 having safe signaling technology can comprise two physically separate FPGA chips or microcontroller chips, for example, which are present with parallel redundancy and are loosely (cyclically) or permanently (lockstep) coupled to one another. In this manner, the clock 16 having safe signaling technology and the protocol state machine 18 having safe signaling technology can be provided in an input and output module 50. Each of the two physically separate chips can provide one channel of a multichannel architecture in this case.

The integration in this case can be performed based on EN 50129 SIL4 and delivers a validation report along with evidence of safety. The result of the integration at the bottommost level is then a COTS component having safe signaling technology. According to the embodiment shown in FIG. 2, a user-programmable unit based on the prior art has become a dedicated input and output module 50 having a permanent, invariable scope of functions that is available with functional capability, including safe clock, synchronization and data link protocols and evidence of safety.

FIG. 3 schematically depicts a computation unit 210 having safe signaling technology based on a second embodiment of the invention.

The main difference over the embodiment shown in FIG. 2 is that instead of the multichannel input and output module 50 having safe signaling technology there are now two diverse input and output modules 152, 154 provided, in each case not necessarily having safe signaling technology, which are combined in the input and output assembly 150 indicated.

Each of the input and output modules 152, 154 comprises a clock 116, 216 and a protocol state machine 218, 318 for executing a data link protocol 18. The instructions for clock processing and the protocol state machine 218, 318 are, as claimed in connection with FIG. 2, hard-encoded in a read only memory 117, 217 of the respective input and output module 152, 154. The first input and output module 152 is in diverse form in comparison with the second input and output module 154. Diversity can be present at the level of the hardware used. Alternatively or additionally, the implemented software (clock, protocol state machine) can also be in diverse form.

In a certain respect, the input and output assembly 150 shown in FIG. 3 can be regarded as an assembly that is obtained when the two channels of the input and output module 50 having safe signaling technology from FIG. 2 are separated, as a result of which the input and output modules 152, 154 are obtained.

In combination, the first 152 and the second 154 input and output modules can be regarded as an input and output assembly having safe signaling technology. This applies at least if the main computer 111 comprises a comparison chip 30 configured to compare input data received from the two input and output modules 152, 154.

Protected and timestamped data 120, 220 leaving the computation unit 210 in redundant fashion are compared at the level of the application data 14, 14′ by a comparison chip of a receiving signal-oriented computation unit (not shown) that likewise needs to support the data link protocols implemented by the protocol state machines 218, 318. In the receiving computation unit, the respective timestamps are also checked for whether the clocks 116, 216 are in sync within prescribed limits, only run forward and have not stopped.

The input and output modules 152, 154 can also be produced in the form of system on chip components and provided as COTS components.

FIG. 4 schematically shows steps of a preferred embodiment of an inventive method for transmitting data between computation units having safe signaling technology.

The method comprises the following steps:

In step S1, a main computer having safe signaling technology is provided.

Moreover, in step S2, an input and output module of the type described above that is couplable to the main computer is provided that comprises a protocol state machine for a data link protocol for data transmission and a clock, wherein instructions for clock processing and the protocol state machine are stored as hard sequence control in a read only memory of the input and output module.

According to a first embodiment, a main computer 11 and an input and output module 50 having safe signaling technology as shown in FIG. 2 are provided.

According to a second embodiment, a main computer 111 and an input and output assembly 150 as shown in FIG. 3 can be provided, the latter comprising a first and a second input and output module 152, 154 of the type described above with reference to step S2.

Although the invention has been illustrated and described in more detail by means of preferred exemplary embodiments, the invention is not limited by the disclosed examples, and other variations can be derived therefrom by a person skilled in the art without departing from the scope of protection of the invention.

1-10 (canceled)

11. An input and output module for sending and receiving data via a data line, the module comprising:
a protocol state machine for a data link protocol for data transmission;
a clock; and
a read only memory having stored thereon instructions for clock processing and said protocol state machine as sequence control.

12. The input and output module according to claim 11, wherein:
said protocol state machine is in redundant form as a protocol state machine having safe signaling technology; and
said clock is in redundant form as a clock having safe signaling technology.

13. The input and output module according to claim 12, wherein said protocol state machine is in diversely redundant form.

14. The input and output module according to claim 12, wherein said clock is in diversely redundant form.

15. The input and output module according to claim 11 being a system-on-chip component.

16. An input and output assembly, comprising:
a first input and output module according to claim 11;
a second input and output module according to claim 11;
said first and second input and output modules being in diverse form in comparison with one another.

17. The input and output assembly according to claim 16, wherein said first input and output module is a system-on-chip component and said second input and output module is a system-on-chip component.

18. A system for transmitting data between computation units having safe signaling technology, wherein at least one of the computation units having safe signaling technology comprises:
a main computer having safe signaling technology; and
an input and output module according to claim 12 coupled to said main computer.

19. A system for transmitting data between computation units having safe signaling technology, wherein one of the computation units having safe signaling technology comprises:
a main computer having safe signaling technology;
an input and output assembly coupled to said main computer, said input and output assembly having a first input and output module according to claim 11 and a second input and output module according to claim 11, and wherein said first and second input and output modules are in diverse form compared to one another; and
a comparison module configured to compare data received from said first input and output module with data received from said second input and output module.

20. A method for transmitting data between computation units having safe signaling technology, the method comprising the steps of:
providing a main computer having safe signaling technology; and
providing an input and output module according to claim 11 to be coupled to the main computer.

21. The method according to claim 20, wherein:
the step of providing the input and output module comprises providing an input and output assembly to be coupled to the main computer, the input and output assembly having a first input and output module according to claim 11 and a second input and output module according to claim 11, and wherein the first and second input and output modules are in diverse form compared to one another; and
further comprising providing a comparison module configured to compare data received from the first input and output module with data received from the second input and output module.
